(19) United States
(12) Patent Application Publication
(10) Pub. No.: US 2009/0089479 A1
(43) Pub. Date: Apr. 2, 2009

(54) Method of managing memory, and method and apparatus for decoding multi-channel data

(75) Inventors: Chang-yong Son, Gunpo-si (KR); Do-hyung Kim, Hwaseong-si (KR); Kang-gun Lee, Hwaseong-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/071,286

(22) Filed: Feb. 19, 2008

(30) Foreign Application Priority Data
Oct. 1, 2007 (KR) 10-2007-0098894

(51) Int. Cl. G06F 12/00

(52) U.S. Cl. 711/100; 711/E12.001

(57) ABSTRACT

A memory management method is provided. In the method, a spatial parameter included in an encoding result is represented as a vector of a time slot and a frequency band in a first domain, a temporary matrix is calculated in the first domain by using the difference between vectors of a current time slot and a previous time slot at the same frequency band and then is stored in a memory, and then a matrix needed to decode the encoding result is represented as a matrix for a time slot and a frequency band in a second domain by using the temporary matrix, thereby reducing the load on the memory for storing matrices on which a decoding operation is performed.

### CROSS-REFERENCE TO RELATED APPLICATIONS

This application claims the benefit of Korean Patent Application No. 10-2007-0098894, filed on Oct. 1, 2007, in the Korean Intellectual Property Office, the disclosure of which is incorporated herein in its entirety by reference.

### BACKGROUND

1. Field

One or more embodiments of the present invention relate to a memory management method, and more particularly, to a memory management method performed during a data decoding operation and a method and apparatus for decoding multi-channel data.

2. Description of the Related Art

Audio data decoding includes a plurality of decoding operations that support a plurality of decoding modes. Thus either a plurality of pieces of table data containing information which is referred to when each of the decoding operations is performed or a plurality of programs used for the decoding operations are needed. For this reason, an audio data decoding system requires a large amount of memory capable of storing a plurality of pieces of table data or a plurality of programs.

### SUMMARY

One or more embodiments of the present invention provide a memory management method capable of reducing the load on a memory that stores a matrix referred to in a decoding operation, and a computer readable medium having recorded thereon a program for executing the memory management method.

One or more embodiments of the present invention also provide a multi-channel data decoding method and apparatus capable of reducing the load on a memory that stores a matrix referred to in a decoding operation, and a computer readable medium having recorded thereon a program for executing the decoding method.

Additional aspects and/or advantages will be set forth in part in the description which follows and, in part, will be apparent from the description, or may be learned by practice of the invention.

According to an aspect of the present invention, there is provided a method of managing memory, the method including representing spatial parameters included in an encoding result as a vector for a time slot and a frequency band in a first domain, calculating a temporary matrix in the first domain by using the difference between vectors of a current time slot and a previous time slot at the same frequency band and then storing the temporary matrix in a memory, and representing a matrix, which is used for decoding the encoding result, as a matrix for a time slot and a frequency band in a second domain by using the temporary matrix.

According to another aspect of the present invention, there is provided a computer readable medium having recorded thereon a program for executing a method of managing memory, the method including representing spatial parameters included in an encoding result as a vector for a time slot and a frequency band in a first domain, calculating a temporary matrix in the first domain by using the difference between vectors of a current time slot and a previous time slot at the same frequency band and then storing the temporary matrix in a memory, and representing a matrix, which is used for decoding the encoding result, as a matrix for a time slot and a frequency band in a second domain by using the temporary matrix.

According to another aspect of the present invention, there is provided a method of decoding multi-channel data, the method including generating a direct signal and a plurality of signals that are to be decorrelated by performing an operation on a first matrix and an input signal in a second domain, where the first matrix is generated from a first temporary matrix for a time slot and a frequency band in a first domain, decorrelating the signals, which are to be decorrelated, by delaying each of the signals for a predetermined delay of time, and generating a multi-channel signal by performing an operation on a second matrix, the direct signal, the decorrelated signals, and residual signals corresponding to the decorrelated signals in the second domain, where the second matrix is generated from a second temporary matrix for a time slot and a frequency band in the first domain.

According to another aspect of the present invention, there is provided a computer readable medium having recorded thereon a program for executing a method of decoding multi-channel data, the method including generating a direct signal and a plurality of signals that are to be decorrelated by performing an operation on a first matrix and an input signal in a second domain, where the first matrix is generated from a first temporary matrix for a time slot and a frequency band in a first domain, decorrelating the signals, which are to be decorrelated, by delaying each of the signals for a predetermined delay of time, and generating a multi-channel signal by performing an operation on a second matrix, the direct signal, the decorrelated signals, and residual signals corresponding to the decorrelated signals in the second domain, where the second matrix is generated from a second temporary matrix for a time slot and a frequency band in the first domain.

According to another aspect of the present invention, there is provided a apparatus for decoding multi-channel data, the apparatus including a first matrix application unit to generate a direct signal and a plurality of signals that are to be decorrelated by performing an operation on a first matrix and an input signal in a second domain, where the first matrix is generated from a first temporary matrix for a time slot and a frequency band in a first domain, a decorrelation unit to decorrelate the signals, which are to be decorrelated, by delaying each of the signals for a predetermined delay of time, and a second matrix application unit to generate a multi-channel signal by performing an operation on a second matrix, the direct signal, the decorrelated signals, and residual signals corresponding to the decorrelated signals in the second domain, where the second matrix is generated from a second temporary matrix for a time slot and a frequency band in the first domain.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a flowchart illustrating a method of transforming a signal processing domain in order to extract spatial parameters during Motion Pictures Experts Group (MPEG) surround encoding, according to an embodiment of the present invention;

FIG. 2 is a block diagram illustrating a multi-channel decoding apparatus related to a 5-1-5 configuration for MPEG surround decoding, according to an embodiment of the present invention;

FIG. 3 is a flowchart illustrating a method of transforming a domain of a matrix used for an up-mixing operation during MPEG surround decoding, according to an embodiment of the present invention;

FIG. 4 is a flowchart illustrating a method of transforming a domain of a matrix used for an up-mixing operation during MPEG surround decoding, according to an embodiment of the present invention; and

FIG. 5 is a conceptual diagram illustrating transformation of a domain of a matrix during MPEG surround decoding, according to an embodiment of the present invention.

### DETAILED DESCRIPTION OF EMBODIMENTS

Reference will now be made in detail to embodiments, examples of which are illustrated in the accompanying drawings, wherein like reference numerals refer to like elements throughout. Embodiments are described below to explain the present invention by referring to the figures.

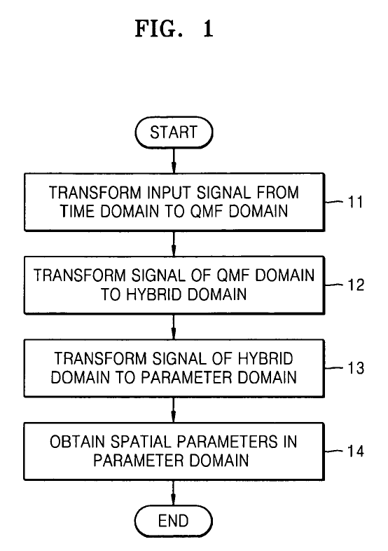

FIG. 1 is a flowchart illustrating a method of transforming a signal processing domain in order to extract spatial parameters during Motion Pictures Experts Group (MPEG) surround encoding, according to an embodiment of the present invention.

MPEG surround encoding is a technique of down-mixing a multi-channel signal to a stereo signal or a mono signal, encoding the down-mixed signal, and then transmitting the encoded down-mixed signal together with spatial information.

Referring to FIG. 1, in operation 11, Quadrature Mirror Filterbanks (QMF) transformation may be performed on a signal transmitted to an encoding unit in order to transform the signal from the time domain to a time/frequency domain, that is, into a QMF domain. For example, 2048 samples of the signal in the time domain may be QMF-transformed into a signal according to a maximum number of 72 time slots and a maximum number of 128 bands.

In the case of an audio signal, a high-frequency band generally contains a large amount of noise while a low-frequency band contains more data than the high-frequency band. Thus the quality of sound may be improved by assigning more bits to encoding of the low-frequency band when the audio signal is encoded. However, the signal of the QMF domain may be divided into a plurality of frequency bands according to a predetermined bandwidth in the frequency domain, and thus the bandwidths of the low-frequency band and the high-frequency band may be maintained at a constant level.

In operation 12, the signal of the QMF domain may be transformed into a hybrid domain. More specifically, the signal of the QMF domain may be additionally filtered to be transformed into the hybrid domain with improved frequency resolution. For example, in the case of the signal of the hybrid domain, a maximum number of time slots is typically 72, which is equal to that of the QMF domain, while a maximum number of bands is typically 135, which is greater than that of the QMF domain. Generally, the greater the total number of bands, the higher the frequency resolution of the signal.

In operation 13, the signal of the hybrid domain may be transformed into a parameter domain. Here, the parameter domain is generally a domain in which spatial parameters representing the spatial information of a signal are obtained. In detail, if signals can be represented with the same spatial parameter in a series of predetermined bands or a series of predetermined time slots in the hybrid domain, the series of predetermined bands or time slots, to which the signals that can be represented with the same spatial parameter belong, may be transformed into one parameter band or one parameter time slot. For example, in the hybrid domain, a maximum number of bands is typically 135, but the number of parameter bands may be reduced to range from 4 to 28. Also, in the hybrid domain, a maximum number of time slots is typically 72, but the number of parameter time slots may be reduced to range from 1 to 8 sets.

In operation 14, spatial parameters may be obtained in the parameter domain. Here, the spatial parameters may include, for example, a Channel Level Difference (CLD) representing the difference between the energy levels of two channels, Inter Channel Correlation/Coherence (ICC) representing the correlation between the two channels, and Channel Prediction Coefficients (CPC), which are prediction coefficients used to generate three channels from the two channels.

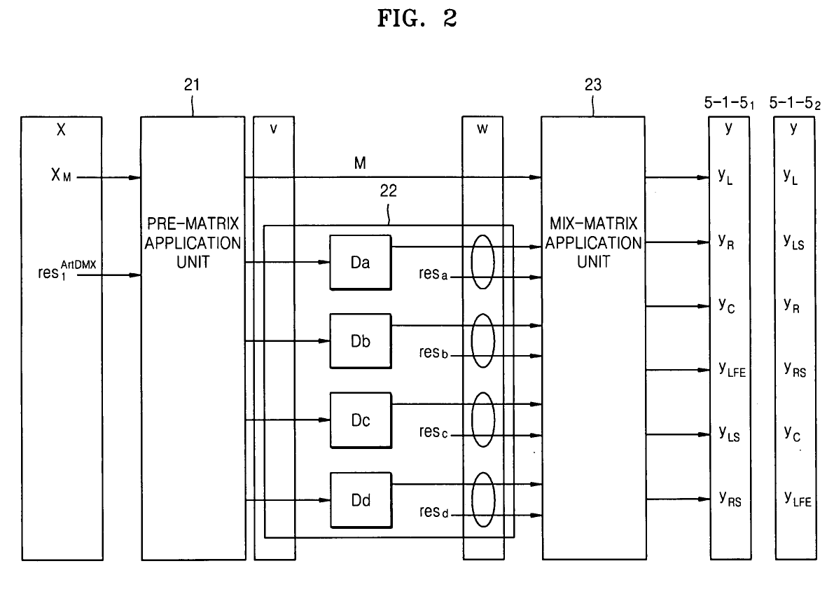

FIG. 2 is a block diagram illustrating a multi-channel decoding apparatus related to a 5-1-5 configuration for MPEG surround decoding, according to an embodiment of the present invention.

MPEG surround decoding is a technique for receiving an encoded down-mixed signal and spatial information, decoding the encoded down-mixed signal, and then generating a multi-channel signal by up-mixing using the decoded down-mixed signal and the spatial information.

Decoding modes in MPEG surround decoding may be categorized into a 5-1-5 configuration and a 5-2-5 configuration according to a tree configuration. In the 5-1-5 configuration, a five-channel signal is down-mixed to a one-channel mono signal and then the down-mixed mono signal is up-mixed to a five-channel signal. Likewise, in the 5-2-5 configuration, a five-channel signal is down-mixed to a two-channel stereo signal and then the down-mixed stereo signal is up-mixed to a five-channel signal. The 5-1-5 configuration may be categorized into a 5-1-51 configuration and a 5-5-52 configuration according to the type of signal or an operational environment.

An up-mixing operation in the 5-1-5 configuration will now be described with reference to FIG. 2.

Referring to FIG. 2, the multi-channel decoding apparatus may include, for example, a pre-matrix application unit 21, a decorrelation unit 22, and a mix matrix application unit 23.

In FIG. 2, ‘x’ denotes a vector of a signal input during an up-mixing operation. The input signal may be a down-mixed signal x_{M}. FIG. 2 illustrates the 5-1-5 configuration, and thus the down-mixed signal x_{M} is a mono signal. However, it would be apparent to those of ordinary skill in the art that the down-mixed signal x_{M} may equally denote a stereo signal in the 5-2-5 configuration.

Alternatively, the input signal may be an artistic down-mixed residual signal res₁.^{ArtDmx} Here, the artistic down-mixed residual signal may be a down-mixed residual signal provided directly from the outside. In another embodiment of the present invention, use of the artistic down-mixed residual signal may be optional during the up-mixing operation.

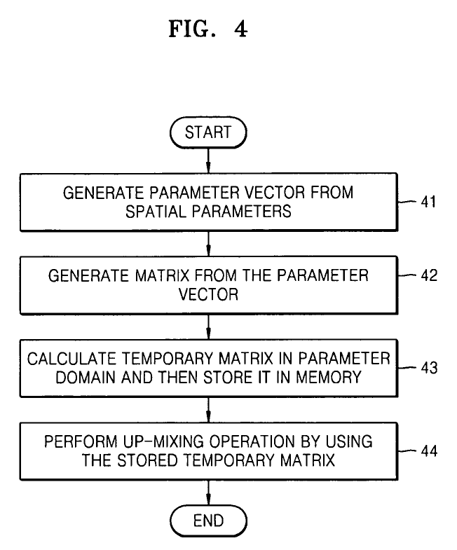

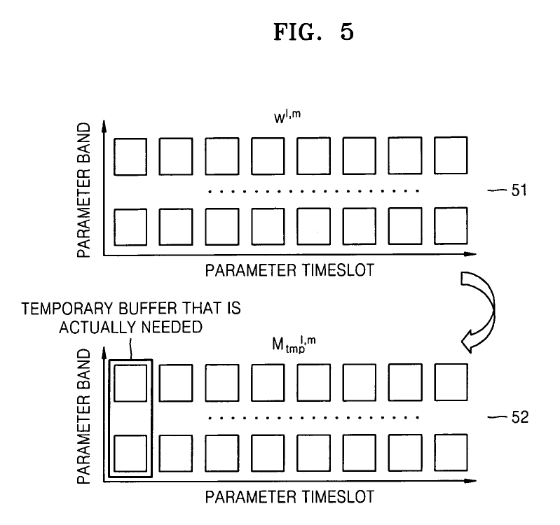

The pre-matrix application unit 21 may perform an operation on the input signal x and a pre-decorrelator matrix M1 in order to generate a direct signal M and a plurality of signals that are to be decorrelated. Here, the pre-decorrelator matrix M1 defines the total number of down-mixed signals x_{M} that are to be input to the decorrelator unit 22. Thus the size of the pre-decorrelator matrix M1 may be determined by the total number of the signals x_{M} input and the total number of decorrelators. Also, the elements constituting the pre-decorrelator matrix M1 may be calculated from spatial parameters. A method of calculating the pre-decorrelator matrix M1 will be described in greater detail later with reference to FIGS. 4 and 5.

In FIG. 2, ‘v’ denotes a vector representing signals output from the pre-matrix application unit 21. For example, ‘v’ may cover one direct signal M and four signals that are to be decorrelated.

The decorrelation unit 22 may include, for example, a plurality of decorrelators Da, Db, Dc, and Dd, and may perform decorrelation in order to reconstruct a signal that is to be decorrelated so that the signal may have spatiality. More specifically, the decorrelators Da, Db, Dc, and Dd may respectively delay one direct signal M for different lengths of time, in order to obtain four decorrelated signals in which the correlation with one direct signal M has been removed. The four decorrelated signals may have spatiality by respectively performing an operation on these signals and residual signals resₐ, res_{b}, res_{c}, and res_{d}.

In FIG. 2, ‘w’ denotes a vector representing one direct signal M output from the pre-matrix application unit 21 and signals output from the decorrelator unit 22.

The mix matrix application unit 23 may perform an operation on the direct signal M generated by the pre-matrix application unit 21, the signals decorrelated by the decorrelation unit 22, and a mix matrix M2 in order to obtain a multi-channel signal.

In FIG. 2, ‘y’ denotes a vector representing multi-channel signals output from the mixed matrix application unit 23. As described above, the 5-1-5 configuration may be divided into the 5-1-51 configuration and the 5-5-52 configuration according to the type of signal or an operational environment. The vector y output in the 5-1-51 configuration may be different than in the 5-5-52 configuration.

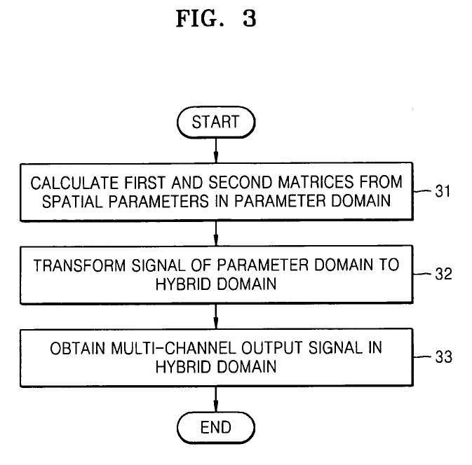

FIG. 3 is a flowchart illustrating a method of transforming a domain of a matrix used for an up-mixing operation during MPEG surround decoding, according to an embodiment of the present invention.

Referring to FIG. 3, in operation 31, a first matrix and a second matrix may be calculated from spatial parameters in a parameter domain. Here, the first and second matrices may be used to perform the up-mixing operation on a down-mixed signal, and may respectively correspond to a pre-decorrelation matrix and a mix matrix. For example, the parameter domain may include four to twenty-eight parameter bands, and one to eight sets of parameter time slots.

In operation 32, the signal of the parameter domain may be transformed into a hybrid domain. In detail, a parameter band in the parameter domain may be transformed into the hybrid domain and then a parameter time slot may be transformed into the hybrid domain, or vice versa.

More specifically, only a parameter band may be transformed into the hybrid domain while maintaining the total number of parameter time slots in the parameter domain. For example, the total number of parameter bands may be increased from a range of 4 to 28 to a maximum number of 135 while maintaining a range of from one to eight sets of parameter time slots. Then the parameter time slots may also be transformed into the hybrid domain. For example, the hybrid domain may include a maximum number of 135 bands and a maximum number of 72 time slots.

In operation 33, a multi-channel output signal may be obtained in the hybrid domain. In other words, the up-mixing operation described with reference to FIG. 2 may be performed in the hybrid domain in order to generate a multi-channel output signal having a vector y.

FIG. 4 is a flowchart illustrating a method of transforming a domain of a matrix used for an up-mixing operation during MPEG surround decoding, according to an embodiment of the present invention.

Referring to FIG. 4, in operation 41, a parameter vector W^{l,m} for a parameter time slot l and a parameter band m may be generated from spatial parameters in a parameter domain. Here, the spatial parameters may be received from an encoding terminal, and include, for example, a CLD representing the difference between the energy levels of two channels, an ICC representing the correlation between the two channels, and a CPC which is a prediction coefficient for generating three channels from the two channels.

In operation 42, a matrix M^{n,m} for a hybrid time slot n and the parameter band m may be generated from the parameter vector W^{l,m}. Specifically, a matrix M^{n,m} may be generated from the parameter vector W^{l,m} using an interpolation vector a(n,l) for the hybrid time slot n and the parameter time slot l. Here, the matrix M^{n,m} may be, as an example, the pre-decorrelator matrix M1 or the mix matrix M2, described above with reference to FIG. 2.

Here, the interpolation vector a(n,l) may be expressed as follows in Equation (1).

$$a ( n , l ) = \{ \begin{matrix}\frac{n + 1}{t ( l ) + 1} , & l = 0 \\ \frac{n - t ( l - 1 )}{t ( l ) - t ( l - 1 )} , & otherwise\end{matrix} \qquad Equation ( 1 )$$

Referring to Equation (1), the interpolation vector a(n,l) may be expressed differently depending on whether the parameter time slot l is zero.

The matrix M^{n,m} may be expressed as follows in Equation (2).

$$\begin{matrix}{M}^{n , m} = a ( n , l ) * {W}^{l , m} + ( 1 - a ( n , l ) ) * {W}^{l - 1 , m} \\ = a ( n , l ) * ( {W}^{l , m} - {W}^{l - 1 , m} ) + {W}^{l - 1 , m}\end{matrix} \qquad Equation ( 2 )$$

Referring to Equation (2), the matrix M^{n,m} may be calculated using vectors of a current time slot l and a previous time slot l−1 at the same frequency band m. In other words, the matrix M^{n,m} may be calculated using the vector W^{l,m} of the current time slot l and the current frequency band m and the vector W^{l-1,m} of the previous time slot l−1 and the current frequency band m.

As in Equation (1), the interpolation vector a(n,l) may be expressed differently depending on when the parameter time slot l is zero. Thus the matrix M^{n,m} will now be expanded for two examples, the first example having a parameter time slot l equal to zero and the second example having a parameter time slot that is not equal to zero.

First, if the parameter time slot l equals zero, if the interpolation vector a(n,l) is applied to the matrix M^{n,m}, the matrix M^{n,m} may be expanded as follows in Equation (3).

$$\begin{matrix}{M}^{n , m} = ( \frac{n + 1}{t ( l ) + 1} ) * ( {W}^{l , m} - {W}^{l - 1 , m} ) + {W}^{l - 1 , m} \\ = ( n + 1 ) * ( \frac{{W}^{l , m} - {W}^{l - 1 , m}}{t ( l ) + 1} ) + {W}^{l - 1 , m} \\ = ( n + 1 ) * {M}_{tmp}^{l , m} + {W}^{l - 1 , m}\end{matrix} \qquad Equation ( 3 )$$

Referring to Equation (3) above,

$$\frac{{W}^{l , m} - {W}^{l - 1 , m}}{t ( l ) + 1}$$

is expressed with a temporary matrix Mₜₘₚ.^{l,m} In this case, n is greater than 0 but is less than t(0)+1, i.e., 0<n<t(0)+1.

Next, if the parameter time slot l is not equal to zero, if interpolation vector a(n,l) is applied to the matrix M^{n,m}, the matrix M^{n,m} may be expanded as follows in Equation (4).

Equation (4):

$$\begin{matrix}{M}^{n , m} = ( \frac{n - t ( l - 1 )}{t ( l ) - t ( l - 1 )} ) * ( {W}^{l , m} - {W}^{l - 1 , m} ) + {W}^{l - 1 , m} \\ = ( n - t ( l - 1 ) ) * \frac{{W}^{l , m} - {W}^{l - 1 , m}}{t ( l ) - t ( l - 1 )} + {W}^{l - 1 , m} \\ = ( n + 1 ) * {M}_{tmp}^{l , m} + {W}^{l - 1 , m}\end{matrix}$$

Referring to Equation (4),

$$\frac{{W}^{l , m} - {W}^{l - 1 , m}}{t ( l ) - t ( l - 1 )}$$

is expressed with the temporary matrix Mₜₘₚ.^{l,m} In this case, n is greater than 0 but is less than (t(l)−t(l−1)+1), i.e., 0<n<(t(l)−t(l−1)+1).

Referring to Equations (3) and (4), the matrix M^{n,m} may be expressed regardless of the value of the parameter time slot l, as follows in Equation 5.

$${M}^{n , m} = ( n + 1 ) * {M}_{tmp}^{l , m} + {W}^{l - 1 , m} \qquad Equation ( 5 )$$

Referring to Equation (5), the matrix M^{n,m} may be expressed using the temporary matrix Mₜₘₚ^{l,m}.

In operation 73, the temporary matrix Mₜₘₚ^{l,m} used for calculating the matrix M^{n,m} may be obtained from the parameter domain and then may be stored. More specifically, the temporary matrix Mₜₘₚ^{l,m} for each of the parameter time slot l and the parameter band m may be calculated and stored.

Referring to Equations (3) and (4), the temporary matrix Mₜₘₚ^{l,m} may be expressed as follows in Equation (6):

$${M}_{tmp}^{l , m} = \{ \begin{matrix}\frac{{W}^{l , m} - {W}^{l - 1 , m}}{t ( l ) + 1} , & l = 0 \\ \frac{{W}^{l , m} - {W}^{l - 1 , m}}{t ( l ) - t ( l - 1 )} , & l \neq 0\end{matrix} \qquad Equation ( 6 )$$

Referring to Equation (6), the temporary matrix Mₜₘₚ^{l,m} may be expressed with respect to the parameter time slot l and the parameter band m. The values of the parameter time slot l and the parameter band m are generally less than those of the hybrid time slot n and the hybrid band k. Thus the size of a temporary matrix for the parameter time slot l and the parameter band m when the temporary matrix is stored in memory, is less than that of a matrix for the hybrid time slot n and the hybrid band k.

In operation 74, the up-mixing operation may be performed using the stored temporary matrix Mₜₘₚ^{l,m}. More specifically, as the value of the time slot n increases, the matrix M^{n,m} is calculated using the temporary matrix Mₜₘₚ^{l,m}. Here, the up-mixing operation may be performed in the hybrid domain, and thus the matrix M^{n,m} may be expressed using the M^{n,k} with respect to a hybrid band k, as follows in Equation (7).

$${M}^{n , k} = ( n + 1 ) * {M}_{tmp}^{l , k ( k )} + {W}^{l - k , k ( k )} \qquad Equation ( 7 )$$

wherein k(k) denotes a function of mapping the hybrid band k to the parameter band m.

If the time slot n is zero, Equation (7) may be expressed as follows in Equation (8).

$${M}^{0 , k} = {M}_{tmp}^{l , k ( 0 )} + {W}^{l - 1 , k ( 0 )} \qquad Equation ( 8 )$$

wherein k(0) denotes a function of mapping a hybrid band 0 to the parameter band m.

Thus referring to Equations (7) and (8), the matrix M^{n,k} may be updated by adding Mₜₘₚ^{l,k(n)} to Equation (8) whenever the value of the time slots n increases by one.

In conclusion, the matrix M^{n,k} may be expressed according to the time slot n, as follows in Equation (9).

$${M}^{n , k} = {M}_{tmp}^{l , k ( n )} + {W}^{l - 1 , k ( n )} \qquad Equation ( 9 )$$

FIG. 5 is a conceptual diagram illustrating transformation of a domain of a matrix during MPEG surround decoding, according to an embodiment of the present invention.

Referring to FIG. 5, the reference numeral “51” denotes the parameter vector W^{l,m} generated in operation 41 illustrated in FIG. 4. Here, the x-axis denotes parameter time slots and the y-axis denotes parameter bands. The parameter vector W^{l,m} may denote the vector for a parameter time slot l and a parameter band m, which is generated from spatial parameters in the parameter domain. For example, the total number of parameter time slots may be 8, and the total number of parameter bands may range from 4 to 28. Each of the rectangles typically denotes a parameter vector for a corresponding parameter time slot and parameter band.

The spatial parameters may vary according to a corresponding parameter time slot and parameter band, and thus the parameter vector obtained from the spatial parameters may also vary according to the corresponding parameter time slot and parameter band. Accordingly, parameter vectors, the total number of which is equal to the product of the total number of parameter time slots and the total number of parameter bands, may be obtained. A large amount of memory is generally required in order to store the obtained parameter vectors.

The reference numeral “52” denotes the temporary matrix Mₜₘₚ^{l,m} stored in the memory in operation 43 illustrated in FIG. 4. Here, the x-axis denotes parameter time slots, and the y-axis denotes parameter bands. In other words, according to an embodiment of the present invention, the temporary matrix Mₜₘₚ^{l,m} may be stored in the memory in the parameter domain.

Conventionally, a matrix M^{n,k} for a hybrid time slot n and a hybrid band k is calculated with respect to each corresponding hybrid time slot and hybrid band in the hybrid domain and then is stored in the memory. Since a maximum number of hybrid time slots n is 72 and a maximum number of hybrid bands k is 135, a large amount of memory is required in order to store all matrices M^{n,k} in the hybrid domain memory.

However, according to an embodiment of the present invention, the temporary matrix Mₜₘₚ^{l,m} for a parameter time slot l and a parameter band m may be stored in memory. The total number of parameter time slot l typically range from 1 to 8, and the total number of parameter bands m typically range from 4 to 28, that is respectively, their total numbers are significantly less than the total numbers of hybrid time slot n and hybrid band k. Accordingly, the size of the temporary matrix Mₜₘₚ^{l,m} for the parameter time slot l and the parameter band when the temporary matrix Mₜₘₚ^{l,m} is stored in memory, is usually less than that of the matrix M^{n,k} for the hybrid time slot n and the hybrid band k.

One or more embodiments of the present invention may be applied to compressing/restoring of an audio signal or a video signal in a storage/output device of an audio apparatus, such as a mobile phone, a computer, a wireless apparatus (a hand-held device), or a household video apparatus. Also, one or more embodiments of the present invention may be applied to a digital television broadcast using a multi-channel audio or MPEG surround decoder, a music downloading service, a streaming service, an internet radio, a teleconference, a game audio apparatus, and so on.

As described above, according to one or more embodiments of the present invention, spatial parameters included in the encoding result may be represented as a vector for a time slot and a frequency band in a first domain, a temporary matrix may be calculated in the first domain by using the difference between vectors of a current time slot and a previous time slot at the same frequency band and then stored in a memory, and then a matrix needed to decode the encoding result may be represented as a matrix for a time slot and a frequency band in a second domain by using the temporary matrix, thereby reducing the load on the memory for storing the matrix referred to in a decoding operation.

In addition to the above described embodiments, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as carrier waves, as well as through the Internet, for example. Thus, the medium may further be a signal, such as a resultant signal or bitstream, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

While aspects of the present invention has been particularly shown and described with reference to differing embodiments thereof, it should be understood that these exemplary embodiments should be considered in a descriptive sense only and not for purposes of limitation. Any narrowing or broadening of functionality or capability of an aspect in one embodiment should not considered as a respective broadening or narrowing of similar features in a different embodiment, i.e., descriptions of features or aspects within each embodiment should typically be considered as available for other similar features or aspects in the remaining embodiments.

In addition, although a few embodiments have been shown and described, it would be appreciated by those skilled in the art that changes may be made in these embodiments without departing from the principles and spirit of the invention, the scope of which is defined in the claims and their equivalents.

What is claimed is:

1. A method of managing memory, comprising:
representing spatial parameters included in an encoding result as a vector for a time slot and a frequency band in a first domain;
calculating a temporary matrix in the first domain by using the difference between vectors of a current time slot and a previous time slot at the same frequency band and then storing the temporary matrix in a memory; and
representing a matrix, which is used for decoding the encoding result, as a matrix for a time slot and a frequency band in a second domain by using the temporary matrix.

2. The method of claim 1, further comprising updating the matrix by adding the temporary matrix stored in the memory to the matrix as a value of the time slot in the second domain increases.

3. The method of claim 2, wherein total numbers of time slots and frequency bands in the first domain are respectively less than those of time slots and frequency bands in the second domain.

4. The method of claim 2, wherein the first domain is a parameter domain which is a time/frequency domain for representing the spatial parameters, and
the second domain is a hybrid domain which is a time/frequency domain having a frequency resolution greater than a threshold value.

5. A computer readable medium having recorded thereon a program for executing a method of managing memory, the method comprising:
representing spatial parameters included in the encoding result as a vector for a time slot and a frequency band in a first domain;
calculating a temporary matrix in the first domain by using the difference between vectors of a current time slot and a previous time slot at the same frequency band and then storing the temporary matrix in a memory; and
representing a matrix, which is used for decoding the encoding result, as a matrix for a time slot and a frequency band in a second domain by using the temporary matrix.

6. A method of decoding multi-channel data, comprising:
generating a direct signal and a plurality of signals that are to be decorrelated by performing an operation on a first matrix and an input signal in a second domain, where the first matrix is generated from a first temporary matrix for a time slot and a frequency band in a first domain;
decorrelating the signals, which are to be decorrelated, by delaying each of the signals for a predetermined delay of time; and
generating a multi-channel signal by performing an operation on a second matrix, the direct signal, the decorrelated signals, and residual signals corresponding to the decorrelated signals in the second domain, where the second matrix is generated from a second temporary matrix for a time slot and a frequency band in the first domain.

7. The method of claim 6, wherein total numbers of the time slots and the frequency bands in the first domain are respectively less than those of the time slots and the frequency bands in the second domain.

8. The method of claim 7, wherein the first domain is a parameter domain which is a time/frequency domain for representing spatial parameters, and
the second domain is a hybrid domain which is a time/frequency domain having a frequency resolution greater than a threshold value.

9. A computer readable medium having recorded thereon a program for executing a method of decoding multi-channel data, the method comprising:
generating a direct signal and a plurality of signals that are to be decorrelated by performing an operation on a first matrix and an input signal in a second domain, where the first matrix is generated from a first temporary matrix for a time slot and a frequency band in a first domain;
decorrelating the signals, which are to be decorrelated, by delaying each of the signals for a predetermined delay of time; and
generating a multi-channel signal by performing an operation on a second matrix, the direct signal, the decorrelated signals, and residual signals corresponding to the decorrelated signals in the second domain, where the second matrix is generated from a second temporary matrix for a time slot and a frequency band in the first domain.

10. An apparatus for decoding multi-channel data, comprising:
a first matrix application unit to generate a direct signal and a plurality of signals that are to be decorrelated by performing an operation on a first matrix and an input signal in a second domain, where the first matrix is generated from a first temporary matrix for a time slot and a frequency band in a first domain;
a decorrelation unit to decorrelate the signals, which are to be decorrelated, by delaying each of the signals for a predetermined delay of time; and
a second matrix application unit to generate a multi-channel signal by performing an operation on a second matrix, the direct signal, the decorrelated signals, and residual signals corresponding to the decorrelated signals in the second domain, where the second matrix is generated from a second temporary matrix for a time slot and a frequency band in the first domain.

11. The apparatus of claim 10, wherein total numbers of the time slots and the frequency bands in the first domain are respectively less than those of the time slots and the frequency bands in the second domain.

12. The apparatus of claim 10, wherein the first domain is a parameter domain which is a time/frequency domain for representing spatial parameters, and
the second domain is a hybrid domain which is a time/frequency domain having a frequency resolution greater than a threshold.
